(19) United States
(12) Patent Application Publication
(10) Pub. No.: US 2016/0282848 A1
(43) Pub. Date: Sep. 29, 2016

(54) METHOD FOR ADDITIVE MANUFACTURING

(71) Applicant: Arcam AB, Moelndal (SE)

(72) Inventor: Calle Hellestam, Goeteborg (SE)

(21) Appl. No.: 15/040,590

(22) Filed: Feb. 10, 2016

Related U.S. Application Data
(60) Provisional application No. 62/139,417, filed on Mar. 27, 2015.

(51) Int. Cl. G05B 19/4099

(52) U.S. Cl. CPC G05B 19/4099; G05B 2219/49023

(57) ABSTRACT

A method is provided for forming at least one three-dimensional article through successive fusion of parts of a powder bed. The method involves: providing a model of the at least one three dimensional article, dividing at least two cross sections in said model into a first inner area portion, a second inner area portion and a contour portion, applying a first material layer on a work table, directing at least one energy beam over the work table causing the first material layer to join in selected locations according to the model for forming a partial first cross section of the three dimensional article, applying a second material layer on said work table; and directing at least one energy beam over the work table causing the second material layer to join in selected locations and form a partial second cross section of said three dimensional article.

### CROSS-REFERENCE TO RELATED APPLICATIONS

This application claims priority to and the benefit of U.S. Provisional Patent Application Ser. No. 62/139,417, filed Mar. 27, 2015, the contents of which as are hereby incorporated by reference in their entirety.

### BACKGROUND

1. Technical Field

The present invention relates to a method for forming a three-dimensional article through successive fusion of powder layers.

2. Related Art

Freeform fabrication or additive manufacturing is a method for forming three-dimensional articles through successive fusion of chosen parts of powder layers applied to a worktable. A method and apparatus according to this technique is disclosed in U.S. Pat. No. 7,635,825.

Such an apparatus may comprise a work table on which the three-dimensional article is to be formed, a powder dispenser, arranged to lay down a thin layer of powder on the work table for the formation of a powder bed, a ray gun for delivering energy to the powder whereby fusion of the powder takes place, elements for control of the ray given off by the ray gun over the powder bed for the formation of a cross section of the three-dimensional article through fusion of parts of the powder bed, and a controlling computer, in which information is stored concerning consecutive cross sections of the three-dimensional article. A three-dimensional article is formed through consecutive fusions of consecutively formed cross sections of powder layers, successively laid down by the powder dispenser.

In U.S. Pat. No. 7,635,825 it is further disclosed a method for reducing surfaces and internal stresses in the manufactured product as well as reduced shape deviations. In this method a cross section of the three-dimensional article is divided into a plurality of inner areas and an edge. The plurality of inner areas is melted according to a predetermined pattern in a first step and the edge is fused in a second step.

There is a need in the art for additively three-dimensional objects with further improved material characteristics.

### BRIEF SUMMARY

An object of the invention is to provide a method for forming three-dimensional articles produced by freeform fabrication or additive manufacturing with improved control of material characteristics. The abovementioned object is achieved by the features in the method according to the claims outlined herein.

In a first aspect according to various embodiments of the invention it is provided a method for forming at least one three-dimensional article through successive joining of parts of a material layer, the method comprising the steps of: providing a model of the at least one three dimensional article, dividing cross sections in the model into a plurality of inner area portions and a contour portion, applying a first material layer on a work table, directing at least one energy beam over the work table causing the first material layer to join in selected locations according to the model for forming a partial first cross section of the three dimensional article, wherein the partial first cross section of the three dimensional article is only joined in the contour portion and a first group of the plurality of inner area portions, leaving at least one second group of inner area portions unjoined, applying a second material layer on the work table, and directing at least one energy beam over the work table causing the second material layer to join in selected locations according to the model for forming a partial second cross section of the three dimensional article, wherein the partial second cross section of the three dimensional article is only joined in the contour portion and a third group of inner area portions, leaving at least a fourth group of inner area portions unjoined.

By only joining a portion of the inner area for a number of cross sections the material properties can be improved compared to if the full inner area would be joined for the number of cross section. The number of cross sections may be the complete number of cross sections for the three-dimensional article which is built or just a portion of the total number of cross sections of the three-dimensional article. The material properties for a first portion of the three-dimensional article may be different compared to a second portion of the three-dimensional article by using full melting of inner areas in the first portion and partial melting of inner areas in the second portion. With the inventive method joining may take less time, area deformations may be decreased because hot large areas are eliminated or reduced. Moreover, heat radiation from melted surfaces

In one example embodiment of the present invention the third group of inner area portion in the second material layer is overlapping an un-joined group of inner area portion in the first material layer.

In this example embodiment a pattern which is joining inner areas in a topmost powder layer is overlapping the un-joined inner areas in a previous powder layer. This means that a first cross section of the three-dimensional article is fully joined when a second subsequent cross section is joined at predetermined areas. In an example embodiment the third group of inner area portions in the second material layer is an inverse pattern of the un-joined group of inner area portion in the first material layer. The advantage of this embodiment is that it introduces flexibility in the joining process which may be used for improving material characteristics.

In another example embodiment of the present invention the method further comprising the step of joining the third group of inner area portion in the second material layer simultaneously as joining the unjoined group of inner area portions in the first material layer. A non-limiting and exemplary advantage of at least this embodiment is that a complete joining of a previous material layer is accomplished simultaneously as a subsequent material layer is only partially joined.

In still another example embodiment of the present invention a boundary between the first group of inner area portions and at least one next neighbor inner area portion is laterally shifted from a first material layer to a second material layer of the three dimensional article. A non-limiting and exemplary advantage of at least this embodiment is that the boundaries between inner areas are not stacked upon each other which will further improve the material characteristics of the three-dimensional article.

In yet another example embodiment of the present invention N groups of inner area portions, where 2≦N≦10, are having an equal share of the total inner area of a single cross section. A non-limiting and exemplary advantage of at least this embodiment is that inner area portions are easily created. Another advantage is that energy impinged into the material layer may be easily controlled.

In still another example embodiment of the present invention a group of inner area portions which is to be joined in a first cross section of the three dimensional article has a different share of the total inner area compared to the same group of inner area portions which is to be joined for another cross section of the three dimensional article. A non-limiting and exemplary advantage of at least this embodiment is that an overlap region of material layer which is joined in a previous layer and material layer which is joined in a subsequent layer may be altered from one layer to another, i.e., the overlap may be increased or decreased from one layer to another. This may be used for controlling that inner area boundaries are not stacked upon each other in the three dimensional article.

In yet another example embodiment of the present invention at least a first and a second group of inner area portions are joined with the same source. A non-limiting and exemplary advantage of at least this embodiment is that the present invention may be implemented in existing single joining source additive manufacturing equipment. The joining source may be a laser beam source or a particle beam source such as an electron beam source or an ion beam source.

In still another example embodiment of the present invention at least a first and a second group of inner area portions are joined with at least two sources. A non-limiting and exemplary advantage of at least this embodiment is that the joining speed may be increased by using multiple sources. Another advantage is that a first joining source may join inner areas in a first region and a second joining source may join inner areas in a second region, where the first and second region are laterally separated from each other or partially overlapping each other. The at least two sources may be of the same type or different types, e.g., a laser beam source or a particle beam source such as an electron beam source or an ion beam source.

In still another example embodiment of the present invention the material is powder or liquid. A non-limiting and exemplary advantage of at least this embodiment is that the present invention is applicable for both liquid based additive manufacturing in which the joining may be made through hardening or polymerization as well as powder bed fusion additive manufacturing in which the joining is made through fusion. With the inventive fusing method of powder material may take less time, area deformations may be decreased because hot large areas are eliminated or reduced. Moreover, heat radiation from melted surfaces may be decreased because the melted area for each layer is reduced. The evaporation of material may be reduced because of the reduced area which is melted for each layer.

In still another example embodiment of the present invention the powder may be metallic, plastic or ceramic powder. A non-limiting and exemplary advantage of at least this embodiment is that all types of powder material may be used.

In still another example embodiment a first group of inner area portions is at least one first set of polygons and a second group of inner area portion is at least one second set of polygons. A non-limiting and exemplary advantage of at least this embodiment is that the inner areas may have any polygonal shape.

In still another example embodiment a first and second sets of polygons are arranged in a chess board like pattern. A non-limiting and exemplary advantage of at least this embodiment is that any cross section of a three-dimensional article may be divided in only two sets of polygons but despite this be able to improve the material characteristics of the final three-dimensional article.

In still another example embodiment of the present invention the polygons are arranged so that polygons from any one of the sets will not be next neighbor to a polygon of the same set. A non-limiting and exemplary advantage of at least this embodiment is that a hexagonal pattern or honeycomb pattern may be used, in which there is no crosstalk between next neighbour inner areas in a material layer.

In still another example embodiment of the present invention the inner area portions in the model are joined in a material layer so as to partially overlap with at least one next neighbor inner area portion of the model. A non-limiting and exemplary advantage of at least this embodiment is that the overlap is flexible throughout the build of the three-dimensional article.

In still another example embodiment of the present invention a program element is provided that is configured and arranged when executed on a computer to implement a method for forming at least one three-dimensional article through successive joining of parts of a material layer. The method comprises the steps of: accessing a model of the at least one three dimensional article; dividing cross sections in the model into a plurality of inner area portions and a contour portion; applying a first material layer on a work table; directing at least one energy beam over the work table causing the first material layer to join in selected locations according to the model for forming a partial first cross section of the three dimensional article, wherein the partial first cross section of the three dimensional article is only joined in the contour portion and a first group of the plurality of inner area portions, leaving at least one second group of inner area portions unjoined; applying a second material layer on the work table; and directing at least one energy beam over the work table causing the second material layer to join in selected locations according to the model for forming a partial second cross section of the three dimensional article, wherein the partial second cross section of the three dimensional article is only joined in the contour portion and a third group of inner area portions, leaving at least a fourth group of inner area portions unjoined.

In still another example embodiment of the present invention a computer program product comprising at least one non-transitory computer-readable storage medium having computer-readable program code portions embodied therein is provided. The computer-readable program code portions comprise: an executable portion configured for accessing a model of the at least one three dimensional article; an executable portion configured for dividing cross sections in the model into a plurality of inner area portions and a contour portion; an executable portion configured for applying a first material layer on a work table; an executable portion configured for directing at least one energy beam over the work table causing the first material layer to join in selected locations according to the model for forming a partial first cross section of the three dimensional article, wherein the partial first cross section of the three dimensional article is only joined in the contour portion and a first group of the plurality of inner area portions, leaving at least one second group of inner area portions unjoined; an executable portion configured for applying a second material layer on the work table; and an executable portion configured for directing at least one energy beam over the work table causing the second material layer to join in selected locations according to the model for forming a partial second cross section of the three dimensional article, wherein the partial second cross section of the three dimensional article is only joined in the contour portion and a third group of inner area portions, leaving at least a fourth group of inner area portions unjoined. In certain embodiments a single executable portion may be configured to provide all of the features recited above; in other embodiments (as above) two or more executable portions may be provided.

In still another example embodiment of the present invention a program element configured and arranged when executed on a computer to implement a method for production of at least one three-dimensional article by successively providing powder layers and fusing together of selected areas of the layers, which areas correspond to partial cross sections of the three-dimensional body, is provided. The method comprises the steps of: applying a first powder layer on a work table; fusing the first powder layer in the selected areas, the selected areas being a full contour of the three dimensional article and a first portion of an inner area of the three-dimensional article; and fusing a second portion of the inner area of the three-dimensional article in the first powder layer completely when the first powder layer is covered with at least one second layer, the second portion being distinct relative to the first portion.

In still another example embodiment of the present invention a computer program product comprising at least one non-transitory computer-readable storage medium having computer-readable program code portions embodied therein is provided. The computer-readable program code portions comprise: an executable portion configured for applying a first powder layer on a work table; an executable portion configured for fusing the first powder layer in the selected areas, the selected areas being a full contour of the three dimensional article and a first portion of an inner area of the three-dimensional article; and an executable portion configured for fusing a second portion of the inner area of the three-dimensional article in the first powder layer completely when the first powder layer is covered with at least one second layer, the second portion being distinct relative to the first portion.

In still another example embodiment of the present invention a computer-implemented method for forming at least one three-dimensional article through successive joining of parts of a material layer is provided. The method comprises the steps of: accessing a model of the at least one three dimensional article; dividing, via at least one computer processor, cross sections in the model into a plurality of inner area portions and a contour portion; applying a first material layer on a work table; directing, via the at least one computer processor, at least one energy beam over the work table causing the first material layer to join in selected locations according to the model for forming a partial first cross section of the three dimensional article, wherein the partial first cross section of the three dimensional article is only joined in the contour portion and a first group of the plurality of inner area portions, leaving at least one second group of inner area portions unjoined; applying a second material layer on the work table; and directing, via the at least one computer processor, at least one energy beam over the work table causing the second material layer to join in selected locations according to the model for forming a partial second cross section of the three dimensional article, wherein the partial second cross section of the three dimensional article is only joined in the contour portion and a third group of inner area portions, leaving at least a fourth group of inner area portions unjoined.

In still another example embodiment of the present invention a computer-implemented method for production of at least one three-dimensional article by successively providing powder layers and fusing together of selected areas of the layers, which areas correspond to partial cross sections of the three-dimensional body, is provided. The method comprises the steps of: applying a first powder layer on a work table; fusing, via at least one computer processor, the first powder layer in the selected areas, the selected areas being a full contour of the three dimensional article and a first portion of an inner area of the three-dimensional article; and fusing, via the at least one computer processor, a second portion of the inner area of the three-dimensional article in the first powder layer completely when the first powder layer is covered with at least one second layer, the second portion being distinct relative to the first portion.

Herein and throughout, where an exemplary embodiment is described or an advantage thereof is identified, such are considered and intended as exemplary and non-limiting in nature, so as to not otherwise limit or constrain the scope and nature of the inventive concepts disclosed.

### BRIEF DESCRIPTION OF THE SEVERAL VIEWS OF THE DRAWING(S)

The invention will be further described in the following, in a non-limiting way with reference to the accompanying drawings. Same characters of reference are employed to indicate corresponding similar parts throughout the several figures of the drawings:

FIG. 1 depicts, in a schematic view from above, a first example embodiment of a partially formed first layer according to the invention of a three-dimensional article,

FIG. 2 depicts, in a schematic view from above, a second example embodiment of a partially formed second layer according to the invention of a three-dimensional article,

FIG. 3 depicts, in a schematic view, an example of a known device for producing a three-dimensional product to which the inventive method can be applied,

FIG. 4A depicts, in a schematic side view, a first partially formed layer according to the invention of a three-dimensional article,

FIG. 4B depicts, in a schematic side view, a second partially formed layer according to the invention of a three-dimensional article,

FIG. 4C depicts, in a schematic side view, a third partially formed layer according to the invention of a three-dimensional article,

FIG. 5 depicts, in a schematic side view, a variable boundary position between different groups of inner areas for different cross sections of a three-dimensional article according to the invention,

FIG. 6 depicts a schematic flowchart of an example embodiment of the present invention,

FIG. 7 depicts, in a schematic view from above, a third example embodiment of a partially formed layer according to the invention of a three-dimensional article,

FIG. 8 depicts, in a schematic view from above, a fourth example embodiment of a partially formed layer according to the invention of a three-dimensional article,

FIG. 9 depicts, in a schematic side view, a first partially formed layer on top of which a second partially formed layer is to be fused according to an example embodiment of the invention,

FIG. 10 depicts, in a schematic view from above, an example embodiment of a partially formed layer according to the invention of a three-dimensional article in which inner areas are partially overlapped for consecutive layers,

FIG. 11 is a block diagram of an exemplary system 1020 according to various embodiments,

FIG. 12A is a schematic block diagram of a server 1200 according to various embodiments, and

FIG. 12B is a schematic block diagram of an exemplary mobile device 1300 according to various embodiments.

### DETAILED DESCRIPTION OF VARIOUS EMBODIMENTS

Various example embodiments of the present invention will now be described more fully hereinafter with reference to the accompanying drawings, in which some, but not all embodiments of the invention are shown. Indeed, embodiments of the invention may be embodied in many different forms and should not be construed as limited to the embodiments set forth herein. Rather, these embodiments are provided so that this disclosure will satisfy applicable legal requirements. Unless otherwise defined, all technical and scientific terms used herein have the same meaning as commonly known and understood by one of ordinary skill in the art to which the invention relates. The term “or” is used herein in both the alternative and conjunctive sense, unless otherwise indicated. Like numbers refer to like elements throughout.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

The term “three-dimensional structures” and the like as used herein refer generally to intended or actually fabricated three-dimensional configurations (e.g. of structural material or materials) that are intended to be used for a particular purpose. Such structures, etc. may, for example, be designed with the aid of a three-dimensional CAD system.

The term “two-dimensional structures” and the like as used herein refer generally to substantially planar structures that may be considered as respective “layers” that when taken as a whole define or otherwise form the “three-dimensional structures” defined above. While referred to as “two-dimensional structures” it should be understood that each includes an accompanying thickness in a third dimension, albeit such that the structures remain substantially two-dimensional in nature. As a non-limiting example, a plurality of two-dimensional structures would have to be stacked atop one another so as to achieve a thickness comparable to that of the “three-dimensional structures” defined above and described elsewhere herein.

The term “electron beam” as used herein in various embodiments refers to any charged particle beam. The sources of a charged particle beam can include an electron gun, a linear accelerator and so on.

The term first layer may be the first layer of the three dimensional article. Alternatively the first layer may be the N:th layer from which the inventive method starts to apply.

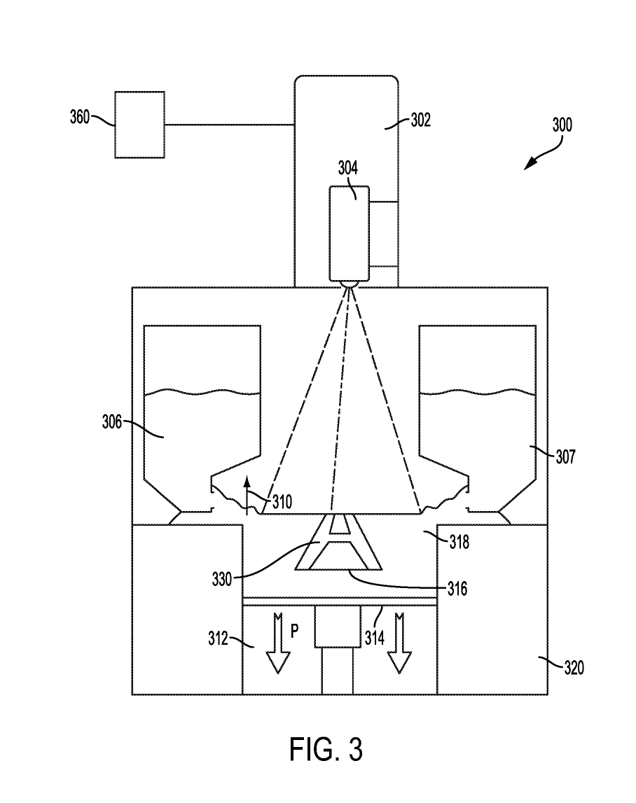

FIG. 3 depicts an example embodiment of a freeform fabrication or additive manufacturing apparatus 300 in which the present inventive method may be implemented. The apparatus 300 comprising an electron gun 302; an optional camera 304; two powder hoppers 306, 307; a start plate 316; a build tank 312; a powder distributor 310; a build platform 314; a control unit 360; and a vacuum chamber 320.

The vacuum chamber 320 is capable of maintaining a vacuum environment by means of or via a vacuum system, which system may comprise a turbo molecular pump, a scroll pump, an ion pump and one or more valves which are well known to a skilled person in the art and therefore need no further explanation in this context. The vacuum system is controlled by a control unit 360.

The electron gun 302 is generating an electron beam which is used for melting or fusing together powder material 318 provided on the start plate 316. The control unit 360 may be used for controlling and managing the electron beam emitted from the electron beam gun 302. At least one focusing coil (not shown), at least one deflection coil (not shown) and an electron beam power supply (not shown) may be electrically connected to the control unit 360. In an example embodiment of the invention the electron gun generates a focusable electron beam with an accelerating voltage of about 60 kV and with a beam power in the range of 0-3 kW. The pressure in the vacuum chamber may be in the range of 1×10⁻³-1×10⁻⁶ mBar when building the three-dimensional article by fusing the powder layer by layer with the energy beam.

Instead of melting the powder material with an electron beam a laser beam may be used. In another example embodiment at least two electron beam sources or at least two laser beam sources or at least one laser beam source and at least one electron beam source may be used. In still another example embodiment more than 2 beam sources may be used which may be of the same type or of different types.

The powder hoppers 306, 307 comprise the powder material to be provided on the start plate 316 in the build tank 312. The powder material may for instance be pure metals or metal alloys such as titanium, titanium alloys, aluminum, aluminum alloys, stainless steel, Co—Cr—W alloy, etc.

The powder distributor 310 is arranged to lay down a thin layer of the powder material on the start plate 316. During a work cycle the build platform 314 will be lowered successively in relation to the beam gun 302 after each added layer of powder material. In order to make this movement possible, the build platform 314 is in one embodiment of the invention arranged movably in vertical direction, i.e., in the direction indicated by arrow P. This means that the build platform 314 starts in an initial position, in which a first powder material layer of necessary thickness has been laid down on the start plate 316. The build platform is thereafter lowered in connection with laying down a new powder material layer for the formation of a new cross section of a three-dimensional article. Means for lowering the build platform 314 may for instance be through a servo engine equipped with a gear, adjusting screws etc.

In an example embodiment of a method according to the present invention for forming at least one three-dimensional article through successive joining of parts of a material layer, comprising a first step 603 of providing a model of the at least one three dimensional article. The model may be generated via a CAD (Computer Aided Design) tool.

In a second step 604 cross sections of the model is divided into a plurality of inner area portions and a contour portion. In an example embodiment each cross section of the model is divided into a plurality of inner area portions and contour portions.

In another example embodiment a predetermined number N of cross sections are divided into the plurality of inner area portions and a contour portion, where N is less than the total number T of cross sections of the three-dimensional article to be built. T-N cross sections may have just one inner area portion. In an example embodiment the T-N cross sections may be distributed evenly between the cross sections with the plurality of inner area portions. In another example embodiment the T-N cross sections may be distributed randomly between the cross sections with the plurality of inner area portions. In still another example embodiment the T-N cross sections are grouped together at predetermined cross sections of the three-dimensional article, e.g., the T-N cross sections may be the first T-N cross sections of the three-dimensional article.

In a third step 606 a first material layer is applied on the work table 316. The material may be powder or liquid material. Powder may be distributed evenly over the worktable according to several methods. One way to distribute the powder is to collect material fallen down from the hopper 306, 307 by a rake system. The rake is moved over the build tank thereby distributing the powder over the start plate. The distance between a lower part of the rake and the upper part of the start plate or previous powder layer determines the thickness of powder distributed over the start plate. The powder layer thickness can easily be adjusted by adjusting the height of the build platform 314. Liquid material may be distributed in several ways. One method may be to lower the worktable successively in a container of the liquid material. Another method may be to apply the liquid material from above the build platform 314 or work table 316.

Instead of starting with the inventive method from a first cross section, the inventive method may start after a predetermined number of layers. This means that for a first predetermined number of layers, cross section are joined fully for each layer. Then after the predetermined number of layers the inventive method may start to apply in which just a portion of the inner area of each cross section is joined for each layer.

In a fourth step 608 at least one energy beam is directed over the work table causing the first material layer to join in selected locations according to the model for forming a partial first cross section of the three dimensional article, wherein the partial first cross section of the three dimensional article is only joined in the contour portion and a first group of the plurality of inner area portions, leaving at least one second group of inner area portions unjoined.

For the first material layer at the second group of inner area portions are left unjoined, which means that a first cross section of the three-dimensional article is only partially joined, i.e., the first group of the inner area portions and the contour portion. The second group of inner area portions which is left unjoined when the first material layer is the top most layer will be joined when the first material layer is covered with one or a plurality of material layers. In the present invention the contour portion of the three dimensional article is joined for all cross sections of the three-dimensional article.

The joining of the material layer may be done with one or a plurality of energy beams. The energy beam(s) may be an electron beam and/or a laser beam. The beam is directed over the work table 316 from instructions given by a control unit 360. In the control unit 360 instructions for how to control the beam sources for each layer of the three-dimensional article is stored.

The joining may be fusion, sintering, hardening or polymerization of the material layer. The material layer may be in powder form or liquid form.

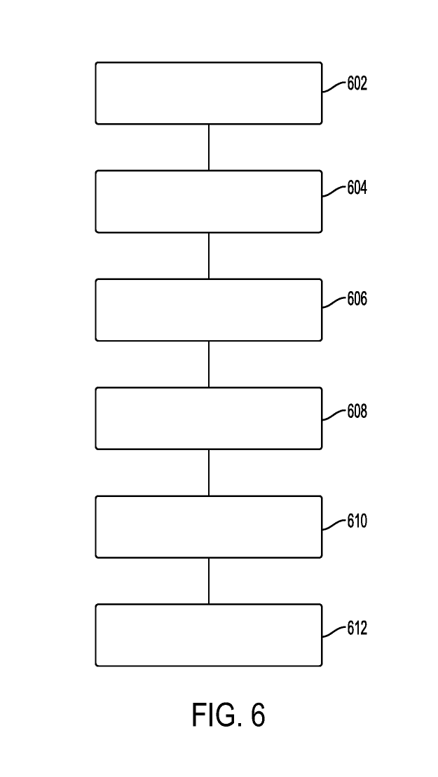

After the first material layer is partially joined, a second material layer is applied on top of the first material layer denoted by step 610 in FIG. 6.

The second material layer is in certain embodiments distributed according to the same manner as the previous layer. However, there might be alternative methods in the same additive manufacturing machine for distributing material. For instance, a first layer may be provided by means of a first powder distributor, a second layer may be provided by another powder distributor. The design of the powder distributor is automatically changed according to instructions from the control unit. A powder distributor in the form of a single rake system, i.e., where one rake is catching powder fallen down from both a left powder hopper 306 and a right powder hopper 307, the rake as such can change design.

After having distributed the second material layer onto the first and partly joined material layer at least one energy beam is directed over the work table causing the second material layer to join in selected locations according to the model for forming a partial second cross section of the three dimensional article, wherein the partial second cross section of the three dimensional article is only joined in the contour portion and a third group of inner area portions, leaving at least a fourth group of inner area portions unjoined, denoted by step 612 in FIG. 6.

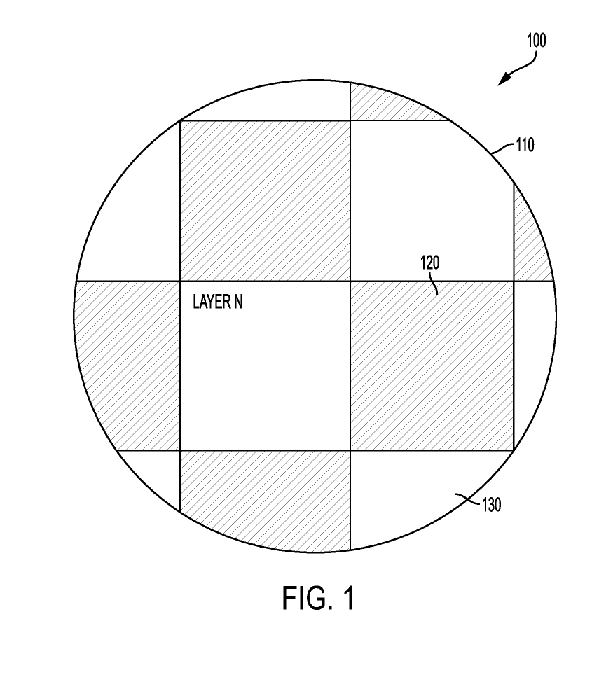

FIG. 1 depicts in a schematic view from above, a first example embodiment of a partially formed first layer according to the invention of a three-dimensional article. In FIG. 1 a cylindrical cross section has been divided in a first group of inner areas 120 and a second group of inner areas 130. A contour 110 is representing the outer surface of the cylinder which is to be manufactured. In a first layer N, the first group of inner areas 120 and the contour 110 are joined leaving the second inner areas 130 unjoined. In FIG. 1 the first and second groups of inner areas are squares and they are arranged in a chessboard pattern. This is just one example of how the first and second groups of inner areas may be arranged.

In another embodiment the first group of inner areas may have a different shape compared to the second inner areas. In yet another example embodiment of the present invention the inner areas within a first group of inner areas may be unequal to its shape. If the first group of inner areas are not identical, then a second group of inner areas may also be unequal.

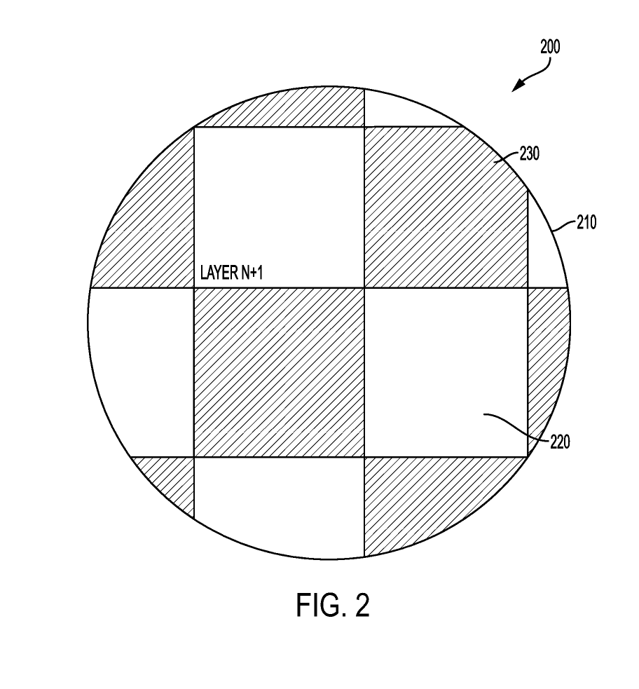

FIG. 2 depicts in a schematic view from above, a first example embodiment of a partially formed second layer according to the invention of a three-dimensional article. In FIG. 2 the cylindrical cross section has been divided in a first group of inner areas 220 and a second group of inner areas 230. A contour 210 is representing the outer surface of the cylinder which is to be manufactured. In the second layer N+1, the second group of inner areas 230 and the contour 110 are joined leaving the first inner areas 220 unjoined. In FIG. 2 the first and second groups of inner areas are, as in FIG. 1, squares and they are arranged in a chessboard pattern.

In FIGS. 1 and 2, there is no overlap between a joined inner area in the second layer with a joined inner area in the first layer.

When the second group of inner areas 230 are joined in the second layer N+1, the second group of inner areas 130 of the first layer N are joined simultaneously. This means that the first layer N is fully joined when the joining of the second layer N+1 has been completed.

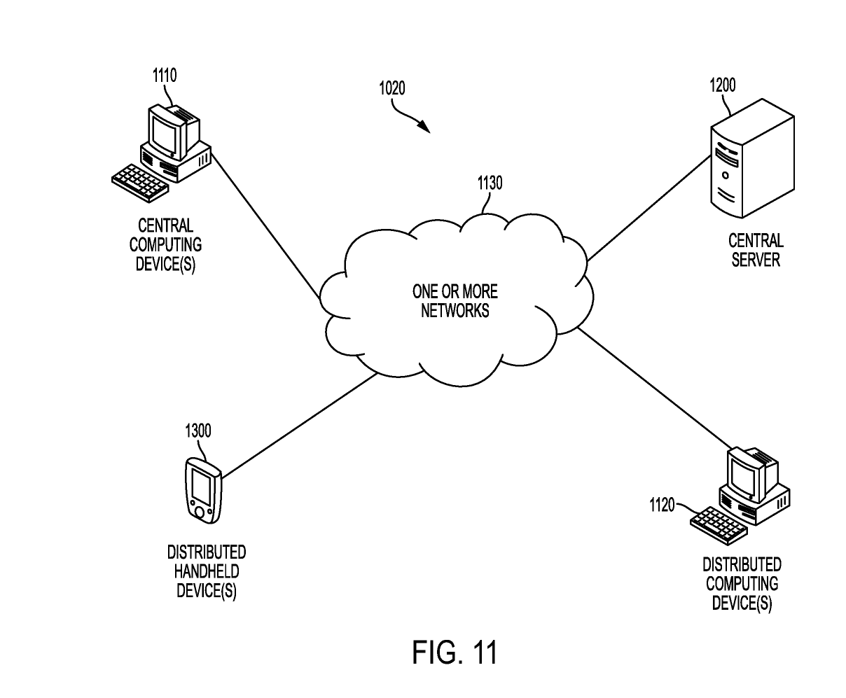

FIG. 10 depicts, in a schematic view from above, an example embodiment of a partially formed layer according to the invention of a three-dimensional article with a cylindrical cross section 1000, in which inner areas are partially overlapped for consecutive layers. Instead of as depicted in FIGS. 1 and 2, where there is no overlap between joined groups of inner areas in a first layer and joined groups of inner areas in a second layer, in FIG. 10 there is an overlap of joined groups of inner areas of a first layer and a second layer.

In FIG. 10 the cross section 1000 of the cylinder is divided in a chessboard pattern having vertical boarder lines 1050 and horizontal border lines 1060. The chess board pattern comprises a first group of inner areas and a second group of inner areas. A contour 1010 is surrounding the first group of inner areas and the second group of inner areas. The first group of inner areas 1020 is joined completely. The second group of inner areas comprises an unjoined portion 1030 and a joined portion 1040. The joined portion 1040 is joined simultaneously as the first group of inner areas 1020 is joined. This means that first group of inner areas 1020 is overlapped into the second group of inner areas denoted by 1040. The overlap is in FIG. 10 extending a distance H upwards and downwards and a distance B to the left and to the right. In an alternative embodiment the overlap downwards may be different to the overlap upwards, i.e., the unjoined portion 1030 may be shifted upwards or downwards instead of being centered as in FIG. 10. In still another example embodiment the overlap to the right may be different to the overlap to the left, i.e., the unjoined portion 1030 may be shifted to the left or to the right instead of being centered as in FIG. 10. In yet another example embodiment the unjoined portion may be shifted upwards or downwards at the same time as being shifted to the right or to the left.

The joined portion 1040 in the topmost layer is overlapping an already joined portion in the previous layer. The first group of inner areas 1020 which is joined in the topmost layer is overlapping an unjoined area in the previous layer. The unjoined area in the previous layer is joined simultaneously as the first group of inner areas 1020 in the topmost layer.

In an example embodiment the first group of inner areas is overlapped into the second group of inner areas for every second layer. The overlap may be upwards, downwards, to the left and/or to the right. In the remaining layers the first and second group of inner areas are kept at their nominal sizes, defines by the vertical lines 1050 and the horizontal lines 1060 without overlap. The lines dividing the inner areas may in an example embodiment be meandering.

In still an example embodiment the first group of inner areas is overlapped into the second group of inner areas for every second layer. The overlap may be upwards, downwards, to the left and/or to the right. In the remaining layers the second group of inner areas is overlapped into the first group of inner areas for every second layer. The overlap may be upwards, downwards, to the left and/or to the right. The overlap into the first group of inner areas are depicted with B′ and H′ in FIG. 10, where B′ is the overlap to the left or right into the first group of inner areas and H′ is the overlap upwards or downwards into the first group of inner areas. B′ and H′ may be equal or unequal.

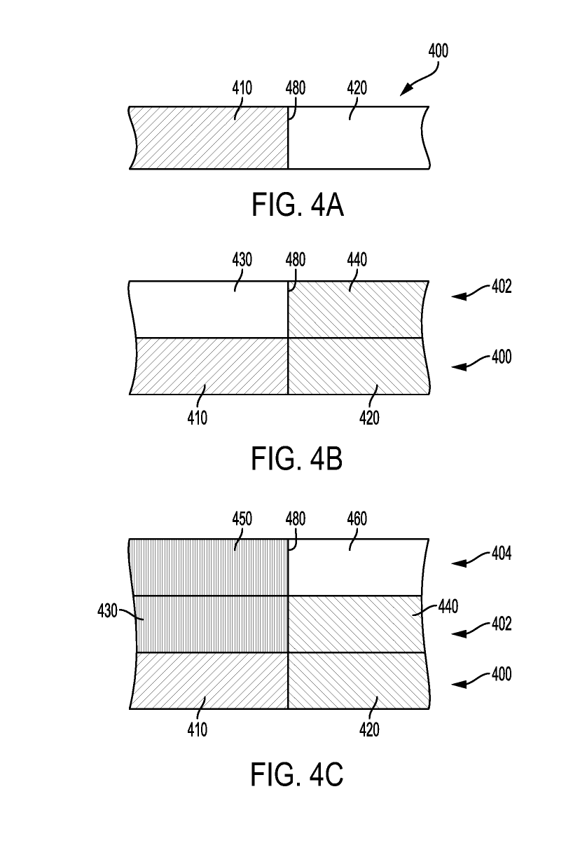

FIG. 4A depicts, in a schematic side view, a first partially formed layer 400 according to the invention of a three-dimensional article. A first portion 410 is joined and a second portion 420 is unjoined.

FIG. 4B depicts, in a schematic side view, a second partially formed layer 402 according to the invention of a three-dimensional article, which second layer 402 is applied on the first layer 400 in FIG. 4A. The second layer 402 is joined in a second portion 440 and unjoined in a first portion 430. The second portion 440 in the second layer 402 is joined simultaneously as the second portion 420 in the first layer 400.

FIG. 4c depicts, in a schematic side view, a third partially formed layer 404 according to the invention of a three-dimensional article, which third layer 404 is applied on the second layer 402 in FIG. 4B. The third layer 404 is joined in a first portion 450 and unjoined in a second portion 460. The first portion 450 in the third layer 404 is joined simultaneously as the first portion 430 in the second layer 402.

In FIGS. 4A, 4B and 4c a dividing line 480, 482, 484 between the first and second portions in respective layers are stacked upon each other.

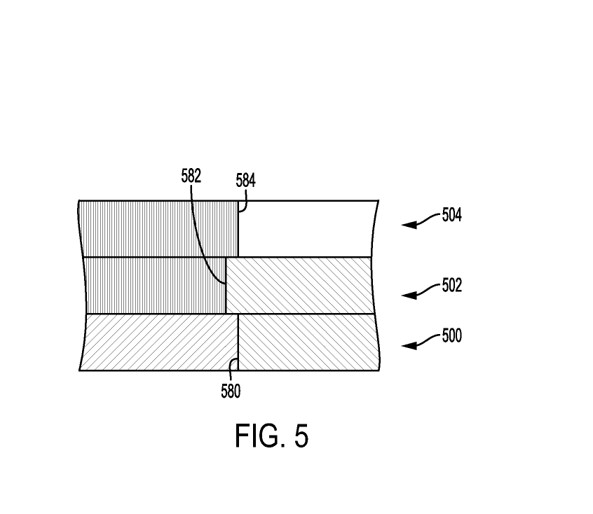

In FIG. 5 a dividing line 480 in the first layer 400 is not applied directly below a dividing line 482 in a second layer 402, which in turn is not directly below a dividing line 484 in the third layer 404. The position of the dividing line 480, 482, 484 may as in FIG. 5 be at a first place for every second layer and at a second place for the reminding layers. Alternatively the dividing line 480, 482, 484 may be arranged at a random position within a specified dividing region.

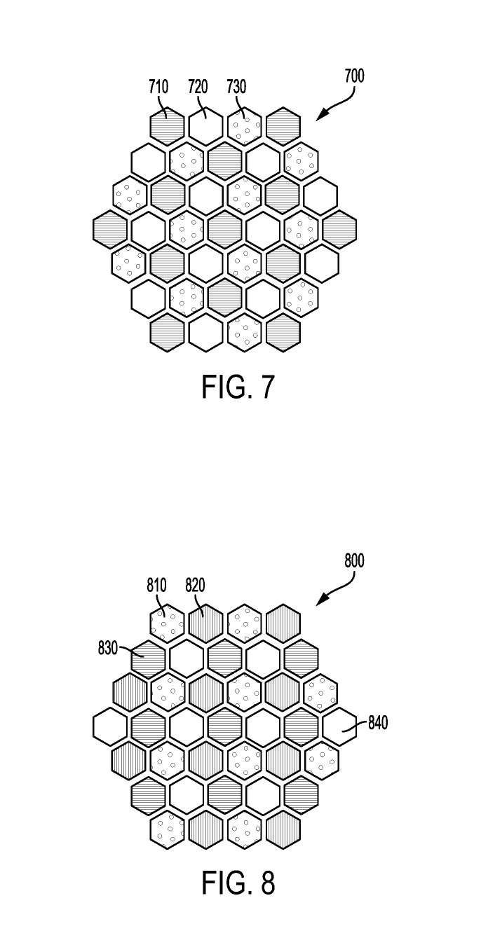

FIG. 7 depicts, in a schematic view from above another example embodiment of a partially formed layer 700 according to the invention of a three-dimensional article. In this embodiment each inner area has a hexagonal shape. The hexagonal shaped inner areas from the different groups are covering the complete inner are of each layer of the three-dimensional article. In this embodiment the three-dimensional article is divided into a first group of inner areas 710, a second group of inner areas 720, a third group of inner areas 730 and a contour (not shown). In a first material layer the first group of inner areas 710 is joined together with the contour, leaving the second group of inner areas 720 and the third group of inner areas 730 unjoined.

In a second material layer the second group of inner areas 720 is joined together with the contour, leaving the first group of inner areas 710 and the third group of inner areas 730 unjoined. The second group of inner areas 720 in the second layer is joined simultaneously as the second group of inner areas in the first layer.

In a third material layer the third group of inner areas 730 is joined together with the contour, leaving the first group of inner areas 710 and the second group of inner areas 720 unjoined. The third group of inner areas 730 in the third layer is joined simultaneously as the third group of inner areas 730 in the first layer and the third group of inner areas 730 in the second layer.

Instead of joining one group of inner areas and leaving the two other unjoined for each layer, two groups of inner areas may be joined and thereby leaving one group of inner areas unjoined for each layer.

Alternatively, in a first layer one group of inner areas may be joined together with the contour, leaving the two other groups of inner areas unjoined. In a second layer two groups of inner areas are joined together with the contour leaving the reminding group of inner area unjoined. In a third layer all groups of inner areas are joined together with the contour.

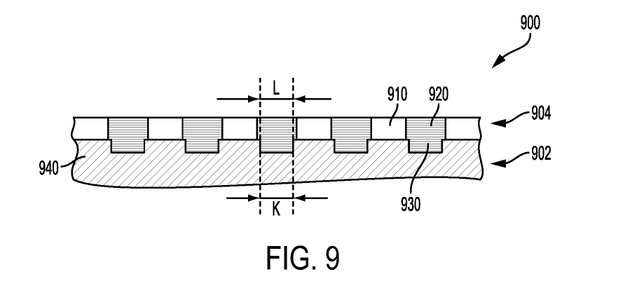

FIG. 8 depicts, in a schematic view from above, still another example embodiment of a partially formed layer 800 according to the invention of a three-dimensional article.

In this embodiment the layer of the three-dimensional article is divided into a first group of inner areas 810, a second group of inner areas 820, a third group of inner areas 830, a fourth group of inner areas 840 and a contour (not shown). In this embodiment each inner area has a hexagonal shape. The hexagonal shaped inner areas from the different groups are covering the complete inner are of each layer of the three-dimensional article.

In a first material layer the first group of inner areas 810 is joined together with the contour, leaving the second group of inner areas 820, the third group of inner areas 730 and the fourth group of inner areas unjoined.

In a second material layer the second group of inner areas 820 is joined, leaving the first group of inner areas 810, the third group of inner areas 830, the fourth group of inner areas 840 unjoined. The second group of inner areas 820 in the second layer is joined simultaneously as the second group of inner areas 820 in the first layer.

In a third material layer the third group of inner areas 830 is joined together with the contour, leaving the first group of inner areas 810, the second group of inner areas 820, the fourth group of inner areas 840 unjoined. The third group of inner areas 830 in the third layer is joined simultaneously as the third group of inner areas 830 in the first layer and the third group of inner areas 830 in the second layer.

In a forth material layer the fourth group of inner areas 840 is joined together with the contour, leaving the first group of inner areas 810, the second group of inner areas 820 and the third group of inner areas 830 unjoined. The fourth group of inner areas 840 in the fourth layer is joined simultaneously as the fourth group of inner areas 840 in the first layer and the fourth group of inner areas 840 in the second layer and the fourth group of inner areas 840 in the third layer.

Instead of joining one group of inner areas together with the contour and leaving the reminder unjoined for each layer, two or three groups of inner areas in FIG. 8 may be joined together with the contour and thereby leaving one or two groups of inner areas unjoined for each layer.

Alternatively, in a first layer one group of inner areas may be joined together with the contour leaving the three other groups of inner areas unjoined. In a second layer two groups of inner areas are joined together with the contour leaving the reminding two groups of inner area unjoined. In a third layer three groups of inner areas are joined together with the contour, leaving one group of inner areas unjoined. In a fourth layer all groups of inner areas are joined together with the contour.

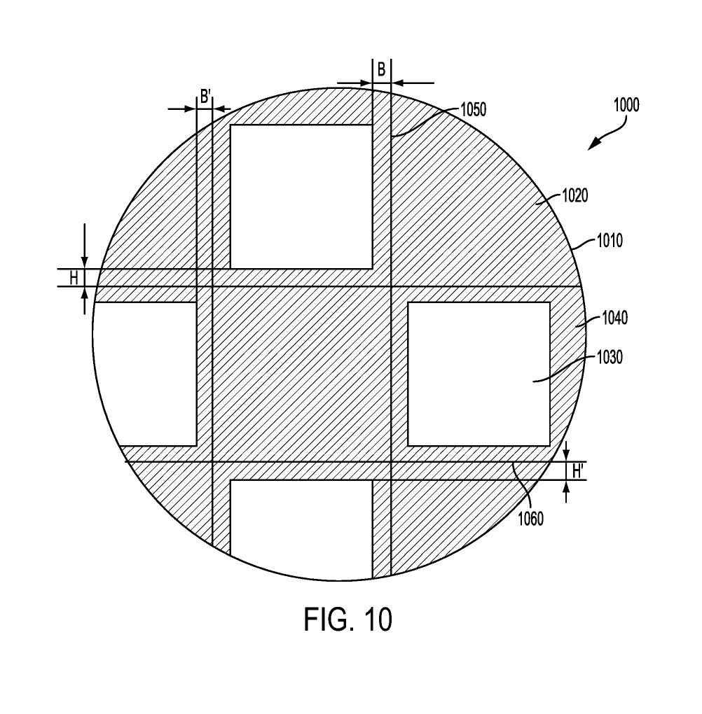

FIG. 9 depicts, in a schematic side view, two partially formed layers 900 which are to be joined according to an example embodiment of the invention. In a first layer 902 a first group of inner areas 940 is joined together with a contour of the three-dimensional article (not shown). A second group of inner areas 930 is left unjoined. The unjoined second group of inner areas in the first layer 902 has an individual width denoted by K.

In a second layer 904 a second group of inner areas 920 is joined simultaneously as the second group of inner areas 930 of the first layer 902 together with the contour of the three-dimensional article in the second layer. The second group of inner areas 920 in the second layer 904 has an individual width denoted by L, where L>K. A first group of inner areas 910 of the second layer is left unjoined. The width L of the second group of inner areas 920 in the second layer 904 is larger than the width K of the second group of inner areas 930 in the first layer 902. The second group of inner areas 920 in the second layer 904 are completely overlapping the second group of inner areas 930 in the first layer 902. Given that the width L is larger than the width K, there is an overlap of a joined region 940 in the first layer 902 with a joined region 920 in the second layer 904. The overlap may be altered from one layer to another by increasing or decreasing the width K and/or L. A center position of the overlap may be altered by shifting the first and second groups of inner areas laterally in a predetermined distance in a predetermined direction.

A first group of inner areas may be joined by using a first joining pattern. A second group of inner areas may be joined by using a second joining pattern. In a case where the joining is fusing, the joining pattern may be different fusion pattern. A first group may be fused with parallel fusion lines in a first direction. A second group of inner areas may be fused with parallel fusion lines in a second direction. Instead of using parallel fusion lines meandering fusion lines may be used for one or a plurality of groups of inner areas.

In an example embodiment a first group of inner areas may be fused with parallel scan lines. A second group of inner areas may be fused with meandering scan lines. A third group of inner areas may be fused with a randomized pattern of discrete dots. A particular group of inner areas may change its fusion pattern after a predetermined number of layers, e.g., for the first 10 layers a first group of inner areas may be fused with parallel scan lines and for the nest 10 layers the first group of inner areas may be melted with meandering scan lines or any other type of fusion pattern.

This invention is not limited to additive manufacturing in which powder material is fused layer wise. The invention is also applicable for additive manufacturing processes in which liquid material is joined together layerwize, for instance hardened or polymerized with a laser beam or an electron beam. This may be performed by applying liquid layers on the build platform 4 or start plate 316. The application of liquid layers may be done by successively lowering the start plate 316 or the build platform 314 in a liquid container.

The camera 304, which may be a thermographic camera, may be used for calibration of the energy beam source and/or to determine the temperature and/or topography of a top surface of a material layer.

Not only the topmost material layer may be fused but also at least a fraction of the thickness of the underlying partially formed three dimensional article. The degree of remelting of the underlying partially formed three dimensional article may be determined beforehand. A predetermined thickness of an underlying partially formed three dimensional article in the partially formed three dimensional article 40 may be remelted and/or melted for the first time when the topmost powder layer is fused by the energy beam. The predetermined thickness may be one or several layers below the topmost layer.

The inventive method of covering a partially joined cross section of a three-dimensional article with a new powder layer may be applied in the full three-dimensional article or for predetermined areas/volumes. This means that there may be different joining methods for different areas/volumes of the three dimensional article.

The high energy beam can be a laser beam generated by a laser source instead of or in addition to the exemplified electron beam. Further, the powdery material does not necessarily have to be made of metal but can be of e.g. plastics or a composite material.

The energy beam, which may be a laser beam or an electron beam, not only melts the last applied powder layer but also at least a portion of the layer of material below the powder layer resulting in a melt comprising the powder material and already melted material from a previous fusion process.

In another aspect of the invention it is provided a program element configured and arranged, when executed on a computer, to implement a method for forming at least one three-dimensional article through successive joining of parts of a material layer. The program element may specifically be configured to perform the steps of: accessing a model of the at least one three dimensional article; dividing cross sections in the model into a plurality of inner area portions and a contour portion; applying a first material layer on a work table; directing at least one energy beam over the work table causing the first material layer to join in selected locations according to the model for forming a partial first cross section of the three dimensional article, wherein the partial first cross section of the three dimensional article is only joined in the contour portion and a first group of the plurality of inner area portions, leaving at least one second group of inner area portions unjoined; applying a second material layer on the work table; and directing at least one energy beam over the work table causing the second material layer to join in selected locations according to the model for forming a partial second cross section of the three dimensional article, wherein the partial second cross section of the three dimensional article is only joined in the contour portion and a third group of inner area portions, leaving at least a fourth group of inner area portions unjoined.

In another aspect of the invention it is provided a program element configured and arranged, when executed on a computer, to implement a method for production of at least one three-dimensional article by successively providing powder layers and fusing together of selected areas of the layers, which areas correspond to partial cross sections of the three-dimensional body. The program element may specifically be configured to perform the steps of: applying a first powder layer on a work table; fusing the first powder layer in the selected areas, the selected areas being a full contour of the three dimensional article and a first portion of an inner area of the three-dimensional article; and fusing a second portion of the inner area of the three-dimensional article in the first powder layer completely when the first powder layer is covered with at least one second layer, the second portion being distinct relative to the first portion.

The program elements may be installed in one or more computer readable storage mediums. The computer readable storage mediums may be the control unit 360. The computer readable storage mediums and the program elements, which may comprise computer-readable program code portions embodied therein, may further be contained within a non-transitory computer program product. Further details regarding these features and configurations are provided, in turn, below.

As mentioned, various embodiments of the present invention may be implemented in various ways, including as non-transitory computer program products. A computer program product may include a non-transitory computer-readable storage medium storing applications, programs, program modules, scripts, source code, program code, object code, byte code, compiled code, interpreted code, machine code, executable instructions, and/or the like (also referred to herein as executable instructions, instructions for execution, program code, and/or similar terms used herein interchangeably). Such non-transitory computer-readable storage media include all computer-readable media (including volatile and non-volatile media).

In one embodiment, a non-volatile computer-readable storage medium may include a floppy disk, flexible disk, hard disk, solid-state storage (SSS) (e.g., a solid state drive (SSD), solid state card (SSC), solid state module (SSM)), enterprise flash drive, magnetic tape, or any other non-transitory magnetic medium, and/or the like. A non-volatile computer-readable storage medium may also include a punch card, paper tape, optical mark sheet (or any other physical medium with patterns of holes or other optically recognizable indicia), compact disc read only memory (CD-ROM), compact disc compact disc-rewritable (CD-RW), digital versatile disc (DVD), Blu-ray disc (BD), any other non-transitory optical medium, and/or the like. Such a non-volatile computer-readable storage medium may also include read-only memory (ROM), programmable read-only memory (PROM), erasable programmable read-only memory (EPROM), electrically erasable programmable read-only memory (EEPROM), flash memory (e.g., Serial, NAND, NOR, and/or the like), multimedia memory cards (MMC), secure digital (SD) memory cards, SmartMedia cards, CompactFlash (CF) cards, Memory Sticks, and/or the like. Further, a non-volatile computer-readable storage medium may also include conductive-bridging random access memory (CBRAM), phase-change random access memory (PRAM), ferroelectric random-access memory (FeRAM), non-volatile random-access memory (NVRAM), magnetoresistive random-access memory (MRAM), resistive random-access memory (RRAM), Silicon-Oxide-Nitride-Oxide-Silicon memory (SONOS), floating junction gate random access memory (FJG RAM), Millipede memory, racetrack memory, and/or the like.

In one embodiment, a volatile computer-readable storage medium may include random access memory (RAM), dynamic random access memory (DRAM), static random access memory (SRAM), fast page mode dynamic random access memory (FPM DRAM), extended data-out dynamic random access memory (EDO DRAM), synchronous dynamic random access memory (SDRAM), double data rate synchronous dynamic random access memory (DDR SDRAM), double data rate type two synchronous dynamic random access memory (DDR2 SDRAM), double data rate type three synchronous dynamic random access memory (DDR3 SDRAM), Rambus dynamic random access memory (RDRAM), Twin Transistor RAM (TTRAIVI), Thyristor RAM (T-RAM), Zero-capacitor (Z-RAM), Rambus in-line memory module (RIMM), dual in-line memory module (DIMM), single in-line memory module (SIMM), video random access memory VRAM, cache memory (including various levels), flash memory, register memory, and/or the like. It will be appreciated that where embodiments are described to use a computer-readable storage medium, other types of computer-readable storage media may be substituted for or used in addition to the computer-readable storage media described above.

As should be appreciated, various embodiments of the present invention may also be implemented as methods, apparatus, systems, computing devices, computing entities, and/or the like, as have been described elsewhere herein. As such, embodiments of the present invention may take the form of an apparatus, system, computing device, computing entity, and/or the like executing instructions stored on a computer-readable storage medium to perform certain steps or operations. However, embodiments of the present invention may also take the form of an entirely hardware embodiment performing certain steps or operations.

Various embodiments are described below with reference to block diagrams and flowchart illustrations of apparatuses, methods, systems, and computer program products. It should be understood that each block of any of the block diagrams and flowchart illustrations, respectively, may be implemented in part by computer program instructions, e.g., as logical steps or operations executing on a processor in a computing system. These computer program instructions may be loaded onto a computer, such as a special purpose computer or other programmable data processing apparatus to produce a specifically-configured machine, such that the instructions which execute on the computer or other programmable data processing apparatus implement the functions specified in the flowchart block or blocks.

These computer program instructions may also be stored in a computer-readable memory that can direct a computer or other programmable data processing apparatus to function in a particular manner, such that the instructions stored in the computer-readable memory produce an article of manufacture including computer-readable instructions for implementing the functionality specified in the flowchart block or blocks. The computer program instructions may also be loaded onto a computer or other programmable data processing apparatus to cause a series of operational steps to be performed on the computer or other programmable apparatus to produce a computer-implemented process such that the instructions that execute on the computer or other programmable apparatus provide operations for implementing the functions specified in the flowchart block or blocks.

Accordingly, blocks of the block diagrams and flowchart illustrations support various combinations for performing the specified functions, combinations of operations for performing the specified functions and program instructions for performing the specified functions. It should also be understood that each block of the block diagrams and flowchart illustrations, and combinations of blocks in the block diagrams and flowchart illustrations, could be implemented by special purpose hardware-based computer systems that perform the specified functions or operations, or combinations of special purpose hardware and computer instructions.

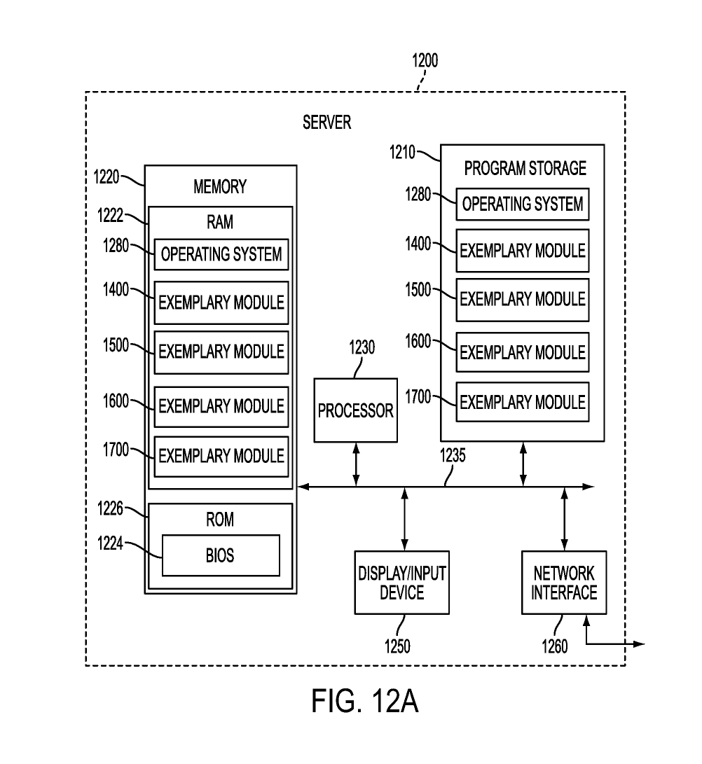

FIG. 11 is a block diagram of an exemplary system 1020 that can be used in conjunction with various embodiments of the present invention. In at least the illustrated embodiment, the system 1020 may include one or more central computing devices 1110, one or more distributed computing devices 1120, and one or more distributed handheld or mobile devices 1300, all configured in communication with a central server 1200 (or control unit) via one or more networks 1130. While FIG. 11 illustrates the various system entities as separate, standalone entities, the various embodiments are not limited to this particular architecture.

According to various embodiments of the present invention, the one or more networks 1130 may be capable of supporting communication in accordance with any one or more of a number of second-generation (2G), 2.5G, third-generation (3G), and/or fourth-generation (4G) mobile communication protocols, or the like. More particularly, the one or more networks 1130 may be capable of supporting communication in accordance with 2G wireless communication protocols IS-136 (TDMA), GSM, and IS-95 (CDMA). Also, for example, the one or more networks 1130 may be capable of supporting communication in accordance with 2.5G wireless communication protocols GPRS, Enhanced Data GSM Environment (EDGE), or the like. In addition, for example, the one or more networks 1130 may be capable of supporting communication in accordance with 3G wireless communication protocols such as Universal Mobile Telephone System (UMTS) network employing Wideband Code Division Multiple Access (WCDMA) radio access technology. Some narrow-band AMPS (NAMPS), as well as TACS, network(s) may also benefit from embodiments of the present invention, as should dual or higher mode mobile stations (e.g., digital/analog or TDMA/CDMA/analog phones). As yet another example, each of the components of the system 1020 may be configured to communicate with one another in accordance with techniques such as, for example, radio frequency (RF), Bluetooth™ infrared (IrDA), or any of a number of different wired or wireless networking techniques, including a wired or wireless Personal Area Network (“PAN”), Local Area Network (“LAN”), Metropolitan Area Network (“MAN”), Wide Area Network (“WAN”), or the like.

Although the device(s) 1110-1300 are illustrated in FIG. 11 as communicating with one another over the same network 1130, these devices may likewise communicate over multiple, separate networks.

According to one embodiment, in addition to receiving data from the server 1200, the distributed devices 1110, 1120, and/or 1300 may be further configured to collect and transmit data on their own. In various embodiments, the devices 1110, 1120, and/or 1300 may be capable of receiving data via one or more input units or devices, such as a keypad, touchpad, barcode scanner, radio frequency identification (RFID) reader, interface card (e.g., modem, etc.) or receiver. The devices 1110, 1120, and/or 1300 may further be capable of storing data to one or more volatile or non-volatile memory modules, and outputting the data via one or more output units or devices, for example, by displaying data to the user operating the device, or by transmitting data, for example over the one or more networks 1130.

In various embodiments, the server 1200 includes various systems for performing one or more functions in accordance with various embodiments of the present invention, including those more particularly shown and described herein. It should be understood, however, that the server 1200 might include a variety of alternative devices for performing one or more like functions, without departing from the spirit and scope of the present invention. For example, at least a portion of the server 1200, in certain embodiments, may be located on the distributed device(s) 1110, 1120, and/or the handheld or mobile device(s) 1300, as may be desirable for particular applications. As will be described in further detail below, in at least one embodiment, the handheld or mobile device(s) 1300 may contain one or more mobile applications 1330 which may be configured so as to provide a user interface for communication with the server 1200, all as will be likewise described in further detail below.

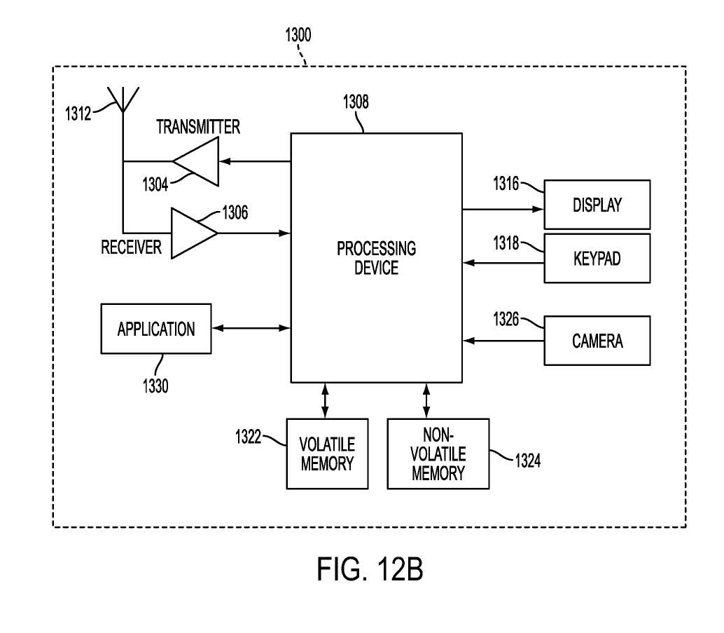

FIG. 12A is a schematic diagram of the server 1200 according to various embodiments. The server 1200 includes a processor 1230 that communicates with other elements within the server via a system interface or bus 1235. Also included in the server 1200 is a display/input device 1250 for receiving and displaying data. This display/input device 1250 may be, for example, a keyboard or pointing device that is used in combination with a monitor. The server 1200 further includes memory 1220, which typically includes both read only memory (ROM) 1226 and random access memory (RAM) 1222. The server's ROM 1226 is used to store a basic input/output system 1224 (BIOS), containing the basic routines that help to transfer information between elements within the server 1200. Various ROM and RAM configurations have been previously described herein.

In addition, the server 1200 includes at least one storage device or program storage 210, such as a hard disk drive, a floppy disk drive, a CD Rom drive, or optical disk drive, for storing information on various computer-readable media, such as a hard disk, a removable magnetic disk, or a CD-ROM disk. As will be appreciated by one of ordinary skill in the art, each of these storage devices 1210 are connected to the system bus 1235 by an appropriate interface. The storage devices 1210 and their associated computer-readable media provide nonvolatile storage for a personal computer. As will be appreciated by one of ordinary skill in the art, the computer-readable media described above could be replaced by any other type of computer-readable media known in the art. Such media include, for example, magnetic cassettes, flash memory cards, digital video disks, and Bernoulli cartridges.

Although not shown, according to an embodiment, the storage device 1210 and/or memory of the server 1200 may further provide the functions of a data storage device, which may store historical and/or current delivery data and delivery conditions that may be accessed by the server 1200. In this regard, the storage device 1210 may comprise one or more databases. The term “database” refers to a structured collection of records or data that is stored in a computer system, such as via a relational database, hierarchical database, or network database and as such, should not be construed in a limiting fashion.

A number of program modules (e.g., exemplary modules 1400-1700) comprising, for example, one or more computer-readable program code portions executable by the processor 1230, may be stored by the various storage devices 1210 and within RAM 1222. Such program modules may also include an operating system 1280. In these and other embodiments, the various modules 1400, 1500, 1600, 1700 control certain aspects of the operation of the server 1200 with the assistance of the processor 1230 and operating system 1280. In still other embodiments, it should be understood that one or more additional and/or alternative modules may also be provided, without departing from the scope and nature of the present invention.

In various embodiments, the program modules 1400, 1500, 1600, 1700 are executed by the server 1200 and are configured to generate one or more graphical user interfaces, reports, instructions, and/or notifications/alerts, all accessible and/or transmittable to various users of the system 1020. In certain embodiments, the user interfaces, reports, instructions, and/or notifications/alerts may be accessible via one or more networks 1130, which may include the Internet or other feasible communications network, as previously discussed.

In various embodiments, it should also be understood that one or more of the modules 1400, 1500, 1600, 1700 may be alternatively and/or additionally (e.g., in duplicate) stored locally on one or more of the devices 1110, 1120, and/or 1300 and may be executed by one or more processors of the same. According to various embodiments, the modules 1400, 1500, 1600, 1700 may send data to, receive data from, and utilize data contained in one or more databases, which may be comprised of one or more separate, linked and/or networked databases.

Also located within the server 1200 is a network interface 1260 for interfacing and communicating with other elements of the one or more networks 1130. It will be appreciated by one of ordinary skill in the art that one or more of the server 1200 components may be located geographically remotely from other server components. Furthermore, one or more of the server 1200 components may be combined, and/or additional components performing functions described herein may also be included in the server.

While the foregoing describes a single processor 1230, as one of ordinary skill in the art will recognize, the server 1200 may comprise multiple processors operating in conjunction with one another to perform the functionality described herein. In addition to the memory 1220, the processor 1230 can also be connected to at least one interface or other means for displaying, transmitting and/or receiving data, content or the like. In this regard, the interface(s) can include at least one communication interface or other means for transmitting and/or receiving data, content or the like, as well as at least one user interface that can include a display and/or a user input interface, as will be described in further detail below. The user input interface, in turn, can comprise any of a number of devices allowing the entity to receive data from a user, such as a keypad, a touch display, a joystick or other input device.

Still further, while reference is made to the “server” 1200, as one of ordinary skill in the art will recognize, embodiments of the present invention are not limited to traditionally defined server architectures. Still further, the system of embodiments of the present invention is not limited to a single server, or similar network entity or mainframe computer system. Other similar architectures including one or more network entities operating in conjunction with one another to provide the functionality described herein may likewise be used without departing from the spirit and scope of embodiments of the present invention. For example, a mesh network of two or more personal computers (PCs), similar electronic devices, or handheld portable devices, collaborating with one another to provide the functionality described herein in association with the server 1200 may likewise be used without departing from the spirit and scope of embodiments of the present invention.

According to various embodiments, many individual steps of a process may or may not be carried out utilizing the computer systems and/or servers described herein, and the degree of computer implementation may vary, as may be desirable and/or beneficial for one or more particular applications.

FIG. 12B provides an illustrative schematic representative of a mobile device 1300 that can be used in conjunction with various embodiments of the present invention. Mobile devices 1300 can be operated by various parties. As shown in FIG. 12B, a mobile device 1300 may include an antenna 1312, a transmitter 1304 (e.g., radio), a receiver 1306 (e.g., radio), and a processing element 1308 that provides signals to and receives signals from the transmitter 1304 and receiver 1306, respectively.

The signals provided to and received from the transmitter 1304 and the receiver 1306, respectively, may include signaling data in accordance with an air interface standard of applicable wireless systems to communicate with various entities, such as the server 1200, the distributed devices 1110, 1120, and/or the like. In this regard, the mobile device 1300 may be capable of operating with one or more air interface standards, communication protocols, modulation types, and access types. More particularly, the mobile device 1300 may operate in accordance with any of a number of wireless communication standards and protocols. In a particular embodiment, the mobile device 1300 may operate in accordance with multiple wireless communication standards and protocols, such as GPRS, UMTS, CDMA2000, 1×RTT, WCDMA, TD-SCDMA, LTE, E-UTRAN, EVDO, HSPA, HSDPA, Wi-Fi, WiMAX, UWB, IR protocols, Bluetooth protocols, USB protocols, and/or any other wireless protocol.

Via these communication standards and protocols, the mobile device 1300 may according to various embodiments communicate with various other entities using concepts such as Unstructured Supplementary Service data (USSD), Short Message Service (SMS), Multimedia Messaging Service (MMS), Dual-Tone Multi-Frequency Signaling (DTMF), and/or Subscriber Identity Module Dialer (SIM dialer). The mobile device 1300 can also download changes, add-ons, and updates, for instance, to its firmware, software (e.g., including executable instructions, applications, program modules), and operating system.

According to one embodiment, the mobile device 1300 may include a location determining device and/or functionality. For example, the mobile device 1300 may include a GPS module adapted to acquire, for example, latitude, longitude, altitude, geocode, course, and/or speed data. In one embodiment, the GPS module acquires data, sometimes known as ephemeris data, by identifying the number of satellites in view and the relative positions of those satellites.

The mobile device 1300 may also comprise a user interface (that can include a display 1316 coupled to a processing element 1308) and/or a user input interface (coupled to a processing element 308). The user input interface can comprise any of a number of devices allowing the mobile device 1300 to receive data, such as a keypad 1318 (hard or soft), a touch display, voice or motion interfaces, or other input device. In embodiments including a keypad 1318, the keypad can include (or cause display of) the conventional numeric (0-9) and related keys (#, *), and other keys used for operating the mobile device 1300 and may include a full set of alphabetic keys or set of keys that may be activated to provide a full set of alphanumeric keys. In addition to providing input, the user input interface can be used, for example, to activate or deactivate certain functions, such as screen savers and/or sleep modes.

The mobile device 1300 can also include volatile storage or memory 1322 and/or non-volatile storage or memory 1324, which can be embedded and/or may be removable. For example, the non-volatile memory may be ROM, PROM, EPROM, EEPROM, flash memory, MMCs, SD memory cards, Memory Sticks, CBRAM, PRAM, FeRAM, RRAM, SONOS, racetrack memory, and/or the like. The volatile memory may be RAM, DRAM, SRAM, FPM DRAM, EDO DRAM, SDRAM, DDR SDRAM, DDR2 SDRAM, DDR3 SDRAM, RDRAM, RIMM, DIMM, SIMM, VRAM, cache memory, register memory, and/or the like. The volatile and non-volatile storage or memory can store databases, database instances, database mapping systems, data, applications, programs, program modules, scripts, source code, object code, byte code, compiled code, interpreted code, machine code, executable instructions, and/or the like to implement the functions of the mobile device 1300.

The mobile device 1300 may also include one or more of a camera 1326 and a mobile application 1330. The camera 1326 may be configured according to various embodiments as an additional and/or alternative data collection feature, whereby one or more items may be read, stored, and/or transmitted by the mobile device 1300 via the camera. The mobile application 1330 may further provide a feature via which various tasks may be performed with the mobile device 1300. Various configurations may be provided, as may be desirable for one or more users of the mobile device 1300 and the system 1020 as a whole.

It will be appreciated that many variations of the above systems and methods are possible, and that deviation from the above embodiments are possible, but yet within the scope of the claims. Many modifications and other embodiments of the invention set forth herein will come to mind to one skilled in the art to which these inventions pertain having the benefit of the teachings presented in the foregoing descriptions and the associated drawings. Such modifications may, for example, involve using a different source of ray gun than the exemplified electron beam such as laser beam. Other materials than metallic powder may be used, such as powder of polymers and powder of ceramics. Therefore, it is to be understood that the inventions are not to be limited to the specific embodiments disclosed and that modifications and other embodiments are intended to be included within the scope of the appended claims. Although specific terms are employed herein, they are used in a generic and descriptive sense only and not for purposes of limitation.

What is claimed:

1. A method for forming at least one three-dimensional article through successive joining of parts of a material layer, said method comprising the steps of:
accessing a model of said at least one three dimensional article;
dividing cross sections in said model into a plurality of inner area portions and a contour portion;
applying a first material layer on a work table;
directing at least one energy beam over said work table causing said first material layer to join in selected locations according to said model for forming a partial first cross section of said three dimensional article, wherein said partial first cross section of said three dimensional article is only joined in said contour portion and a first group of said plurality of inner area portions, leaving at least one second group of inner area portions unjoined;
applying a second material layer on said work table; and
directing at least one energy beam over said work table causing said second material layer to join in selected locations according to said model for forming a partial second cross section of said three dimensional article, wherein said partial second cross section of said three dimensional article is only joined in said contour portion and a third group of inner area portions, leaving at least a fourth group of inner area portions unjoined.

2. The method according to claim 1, wherein said third group of inner area portions in said second material layer is at least partially overlapping said at least one second group of inner area portions unjoined in said first material layer.

3. The method according to claim 2, further comprising the step of joining said third group of inner area portion in said second material layer simultaneously as joining said at least one second group of inner area portions unjoined in said first material layer.

4. The method according to claim 1, wherein a boundary between said first group of inner area portions and at least one next neighboring inner area portion is laterally shifted from a first material layer to a second material layer of said three dimensional article.

5. The method according to claim 1, wherein N groups of inner area portions are provided, where 2≦N≦10, such that each of the N groups has an equal share of the total inner area of a single cross section.

6. The method according to claim 5, wherein a group of inner area portions which is to be joined in a first cross section of the three dimensional article has a different share of the total inner area compared to the same group of inner area portions which is to be joined for another cross section of the three dimensional article.

7. The method according to claim 1, wherein at least a first and a second group of inner area portions are joined with the same source.

8. The method according to claim 1, wherein at least a first and a second group of inner area portions are joined with at least two sources.

9. The method according to claim 8, wherein a first source is an electron beam source and a second source is a laser source.

10. The method according to claim 8, wherein a first and a second source are two different electron beam sources.

11. The method according to claim 8, wherein a first and a second source are two different laser beam sources.

12. The method according to claim 1, wherein said material is at least one of a powder or a liquid.

13. The method according to claim 1, wherein said joining is provided via at least one of a fusing, a hardening, or a polymerization process.

14. The method according to claim 12, wherein said powder is metallic powder.

15. The method according to claim 1, wherein a first group of inner area portions is at least one first set of polygons and a second group of inner area portion is at least one second set of polygons.

16. The method according to claim 15, wherein said first and second sets of polygons are arranged in a chess board like pattern.

17. The method according to claim 15, wherein said polygons are arranged so that polygons from any one of said sets will not be a next neighbor to a polygon of the same set.

18. The method according to claim 15, wherein said inner area portions in said model are joined in a material layer so as to partially overlap with at least one next neighbor inner area portion of said model.

19. The method according to claim 1, wherein:
said model is accessed via one or more memory storage areas; and
one or more of the recited steps are computer-implemented via at least one computer processor.

20. A program element configured and arranged when executed on a computer to implement a method for forming at least one three-dimensional article through successive joining of parts of a material layer, said method comprising the steps of:
accessing a model of said at least one three dimensional article;
dividing cross sections in said model into a plurality of inner area portions and a contour portion;
applying a first material layer on a work table;
directing at least one energy beam over said work table causing said first material layer to join in selected locations according to said model for forming a partial first cross section of said three dimensional article, wherein said partial first cross section of said three dimensional article is only joined in said contour portion and a first group of said plurality of inner area portions, leaving at least one second group of inner area portions unjoined;
applying a second material layer on said work table; and
directing at least one energy beam over said work table causing said second material layer to join in selected locations according to said model for forming a partial second cross section of said three dimensional article, wherein said partial second cross section of said three dimensional article is only joined in said contour portion and a third group of inner area portions, leaving at least a fourth group of inner area portions unjoined.

21. A non-transitory computer readable medium having stored thereon the program element according to claim 20.

22. A computer program product comprising at least one non-transitory computer-readable storage medium having computer-readable program code portions embodied therein, the computer-readable program code portions comprising:
an executable portion configured for accessing a model of said at least one three dimensional article;
an executable portion configured for dividing cross sections in said model into a plurality of inner area portions and a contour portion;
an executable portion configured for applying a first material layer on a work table;
an executable portion configured for directing at least one energy beam over said work table causing said first material layer to join in selected locations according to said model for forming a partial first cross section of said three dimensional article, wherein said partial first cross section of said three dimensional article is only joined in said contour portion and a first group of said plurality of inner area portions, leaving at least one second group of inner area portions unjoined;
an executable portion configured for applying a second material layer on said work table; and
an executable portion configured for directing at least one energy beam over said work table causing said second material layer to join in selected locations according to said model for forming a partial second cross section of said three dimensional article, wherein said partial second cross section of said three dimensional article is only joined in said contour portion and a third group of inner area portions, leaving at least a fourth group of inner area portions unjoined.
